(19) United States
(12) Patent Application Publication
(10) Pub. No.: US 2018/0223230 A1
(43) Pub. Date: Aug. 9, 2018

(54) LAUNDRY DETERGENT SHEET WITH PRINTED GRAPHIC PATTERNS

(71) Applicant: The Procter & Gamble Company, Cincinnati, OH (US)

(72) Inventors: Hong Sing Tan, Beijing (CN); Ming Tang, Beijing (CN); Mark Robert Sivik, Cincinnati, OH (US); Frank William Denome, Cincinnati, OH (US)

(21) Appl. No.: 15/888,114

(22) Filed: Feb. 5, 2018

(30) Foreign Application Priority Data
Feb. 6, 2017 (CN) CN2017/072926

(51) Int. Cl. C11D 17/06; C11D 3/42; C11D 1/83

(52) U.S. Cl. CPC C11D 17/06; C11D 1/24; C11D 1/83; C11D 3/42

(57) ABSTRACT

A non-fibrous laundry detergent sheet is completely or substantially water-soluble, with graphic patterns printed thereon. Such graphic patterns include one or more fabric hueing agents.

### FIELD OF THE INVENTION

This invention relates to a non-fibrous laundry detergent sheet that is completely or substantially water-soluble with graphic patterns printed thereon.

### BACKGROUND OF THE INVENTION

Incorporation of shading or hueing agents into laundry detergent compositions for improving the aesthetic appearance of treated fabrics has been known. Such fabric hueing agents impart to the treated fabrics a slightly colored hue or shade, e.g., a blue or violet hue, that can effectively increase the apparent whiteness of such treated fabrics and renders them aesthetically more pleasing to the eyes of the consumers than fabrics without such hue.

However, when such fabric hueing agents are incorporated into liquid laundry detergent compositions, they may turn the entire liquid laundry detergent composition into a dark green, blue or violet color. Such a dark color is particularly undesirable for Asian consumers, who perceive dark-colored liquids as containing more chemicals and therefore more unnatural or harsher. The Asian consumers usually prefer light-colored liquid laundry detergent compositions, because light-color liquids appear to them as containing less chemicals and therefore more natural or milder. This perception has significantly hindered wider use of fabric hueing agents in liquid laundry detergent compositions in Asian markets. Even when used, the fabric hueing agents are used only in small or moderate amounts, due to fear that they may render the liquid laundry detergent compositions too dark in color to the consumers' liking.

In the past decade, laundry detergent compositions in a sheet-like form that are completely soluble in water have become more popular. Unlike the liquid laundry detergent compositions, such laundry detergent sheets contain little or no water, therefore they are extremely concentrated, easy to transport and handle with little or no risk of leakage, chemically and physically stable during shipment and storage, and have a significantly smaller physical and environmental footprint.

However, incorporation of fabric hueing agents into such new laundry detergent sheets presents a similar issue as in the liquid laundry detergent compositions. All currently in-market laundry detergent sheet products incorporating fabric hueing agents unavoidably are imparted with a green, blue or violet color that is characteristics of the fabric hueing agents they incorporate. Further, because the laundry detergent sheets are significantly smaller in volume and size than traditional liquid laundry detergent compositions, the amount of fabric hueing agents incorporated into such sheets needs to be even more carefully controlled, in order to prevent any negative impact on the overall aesthetic appearance and consumer acceptance of such laundry detergent sheets.

There is therefore a need for laundry detergent sheet products that can freely incorporate fabric hueing agents in sufficient amounts to effectively improve the aesthetic appearance of treated fabrics, but without the above-mentioned negative impact on their overall aesthetic appearance and consumer acceptance.

### SUMMARY OF THE INVENTION

The present invention provides a solution to the above-described problem, by incorporating and localizing the fabric hueing agents into discrete graphic patterns that are printed onto the laundry detergent sheets. On one hand, such discrete graphic patterns containing the fabric hueing agents become aesthetic decorations themselves on the laundry detergent sheets before use, thereby turning an aesthetic negative into an aesthetic positive and rendering such laundry detergent sheets more (instead of less) aesthetically pleasing to the consumers. On the other hand, the fabric hueing agents can now be freely dosed to provide the needed improved whiteness benefit to fabrics through treatment by the laundry detergent sheets.

In one aspect, the present invention relates to a non-fibrous laundry detergent sheet having a first planar surface and a second, opposite planar surface, while the first planar surface comprises a first discrete region and a second discrete region that are characterized by a Color Contrast (ΔE) of at least about 2, while the first discrete region and/or the second discrete region comprises one or more fabric hueing agents selected from the group consisting of dyes, dye-clay conjugates, organic pigments, inorganic pigments and combinations thereof. Such laundry detergent sheet comprises at least one surfactant and at least one film former and is completely or substantially water-soluble. Further, such laundry detergent sheet has a thickness ranging from 0.1 mm to 10 mm, a length-to-thickness aspect ratio of at least 5:1, and a width-to-thickness aspect ratio of at least 5:1.

Preferably, the Color Contrast (ΔE) between the first and second discrete regions is at least about 2.3, more preferably at least about 3, still more preferably at least about 5, and most preferably at least about 6.

The one or more fabric hueing agents may include one or more dyes selected from the group consisting of direct dyes, basic dyes, reactive dyes, solvent dyes, disperse dyes, and combinations thereof.

Such one or more fabric hueing agents may include, either alone or in combination with the above-mentioned dyes, one or more fluorescent dye such as diaminostilbenes, distyrylbiphenyls, and combinations thereof. Preferably, such one or more fluorescent dye are selected from the group consisting of disodium 4,4′-bis{[4-anilino-6-morpholino-s-triazin-2-yl]-amino}-2,2′-stilbenedisulfonate (also referred to as “Fluorescent Brightener 260”), disodium 4,4″-bis[(4,6-di-anilino-s-triazin-2-yl)-amino]-2,2′-stilbenedisulfonate, disodium 4,4′-bis{[4-anilino-6-[bis(2-hydroxyethyl)amino-s-triazin-2-yl]-amino}-2,2′-stilbenedisulfonate, disodium 2,2′-([1,1′-biphenyl]-4,4′-diyldivinylene)bis(benzenesulphonate) (also referred to as “Fluorescent Brightener 351”), and combinations thereof.

In a preferred but not necessary embodiment of the present invention, only one of the first and second discrete regions on the first planar surface of the non-fibrous laundry detergent sheet contains said one or more fabric hueing agents, while the other of such first and second discrete regions is either substantially free of any fabric hueing agents or comprises one or more different fabric hueing agents.

Further, the second planar surface of the non-fibrous laundry detergent sheet may include a third discrete region and a fourth discrete region that are also characterized by a Color Contrast (ΔE) of at least 2, while the third discrete region and/or the fourth discrete region also contains such one or more fabric hueing agents.

In another aspect, the present invention relates to use of the non-fibrous laundry detergent sheet as mentioned hereinabove for cleaning fabrics, preferably for removing stains and/or odors from fabrics.

In still another aspect, the present invention relates to use of the non-fibrous laundry detergent sheet as mentioned hereinabove for pre-treating fabrics before cleaning, by first wetting a section of the fabrics in need of pre-treating, and then directly contacting said unitary non-fibrous laundry detergent structure, or a piece thereof, with said wetted section of the fabrics.

These and other aspects of the present invention will become more apparent upon reading the following detailed description of the invention.

### BRIEF DESCRIPTION OF THE DRAWINGS

FIG. 1 is a perspective view of a prior art non-fibrous laundry detergent sheet containing a colorant that is uniformly distributed therein.

FIG. 2 is a perspective view of a non-fibrous laundry detergent sheet according to one embodiment of the present invention, showing its first planar surface that contains a first printed graphic pattern thereon, which is formed by a fabric hueing agent.

FIG. 3 is a perspective view of the non-fibrous laundry detergent sheet of FIG. 3, showing its second planar surface that contains a second printed graphic pattern thereon, which is also formed by the fabric hueing agent.

FIG. 4 is a front view of a non-fibrous laundry detergent sheet according to another embodiment of the present invention, containing on its front surface a printed graphic pattern with regions of different colors formed by the same fabric hueing agent dosed at different concentrations.

### DETAILED DESCRIPTION OF THE INVENTION

Features and benefits of the various embodiments of the present invention will become apparent from the following description, which includes examples of specific embodiments intended to give a broad representation of the invention. Various modifications will be apparent to those skilled in the art from this description and from practice of the invention. The scope of the present invention is not intended to be limited to the particular forms disclosed and the invention covers all modifications, equivalents, and alternatives falling within the spirit and scope of the invention as defined by the claims.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

As used herein, articles such as “a” and “an” when used in a claim, are understood to mean one or more of what is claimed or described. The terms “comprise,” “comprises,” “comprising,” “contain,” “contains,” “containing,” “include,” “includes” and “including” are all meant to be non-limiting.

As used herein, the term “water-soluble” refers to a solubility of more than about 30 grams per liter (g/L) of deionized water measured at 20° C. and under the atmospheric pressure. The term “substantially water-soluble” refers to a solubility of more than about 25 grams per liter (g/L) of deionized water measured at 20° C. and under the atmospheric pressure.

As used herein, the term “sheet” refers to a three-dimensional shape having a thickness, a length, and a width, while the length-to-thickness aspect ratio and the width-to-thickness aspect ratio are both at least about 5:1, and the length-to-width aspect ratio is at least about 1:1. Preferably, the length-to-thickness aspect ratio and the width-to-thickness aspect ratio are both at least about 10:1, and the length-to-width aspect ratio is at least about 1.2:1. More preferably, the length-to-thickness aspect ratio and the width-to-thickness aspect ratio are both at least about 15:1, and the length-to-width aspect ratio is at least about 1.5:1. Most preferably, the length-to-thickness aspect ratio and the width-to-thickness aspect ratio are both at least about 20:1, and the length-to-width aspect ratio is at least about 1.618:1.

As used herein, the term “non-fibrous” refers to a structure that is free of or substantially free of fibrous elements. “Fibrous element” as used herein means elongated particulate having a length greatly exceeding its average diameter, i.e., a length-to-average-diameter aspect ratio of at least 10:1, and an average diameter of no more than 1 mm.

As used herein, the term “laundry detergent” refers to all-purpose or “heavy-duty” washing agents, especially cleaning detergents, for fabrics, as well as cleaning auxiliaries such as bleach, rinse aids, additives, or pre-treat types.

As used herein, the term “Color Contrast (ΔE)” refers to the average color difference ΔE between the discrete regions as measured in CIELab coordinate values. CIELab is a mathematical color scale based on the Commission Internationale de l'Eclairage (hereinafter “CIE”) 1976 standard. CIELab allows a color to be plotted in a three-dimensional space analogous to the Cartesian xyz space. Any color may be plotted in the CIELab space as a point in a three dimensional, Euclidian, coordinate system according to its three color values, L*, a*, b*, which respectively correspond to lightness/luminosity, chroma, and hue. The term “Lab color” or “L*a*b* Color Space” refers to a color model that is used by those of skill in the art to characterize and quantitatively describe perceived colors with a relatively high level of precision. Therefore, L*a*b* color space can be used to describe the gamut of colors that an ordinary observer may actually perceive visually. One of skill in the art is thus able to approximate perceptual color differences (ΔE) between any two colors A and B by first plotting each color as a point defined by its color values or coordinates (L*, a*, b*) in the CIELab space, and then calculating the Euclidian distance between the two points A and B (ΔE*_{Lab}=[(L*_{A}-L*_{B})²+(a*_{A}-a*_{B})²+(b*_{A}-b*_{B})²]^{1/2}). When referring to the Color Contrast between two regions, it means the average approximate perceptual color difference between points within the two regions, provided that there is little or no perceivable color variation within the same region (i.e., the Color Contrast within any two points in the same region is less than 2 and more preferably less than 1).

As used herein, the term “Water Dissolvability” refers to the ability of a sample material to dissolve in water within a specific time period at 20° C. and under the atmospheric pressure without any stirring. This parameter is measured by placing 10 grams of the sample material in 1 liter of deionized water at 20° C. and under the atmospheric pressure for one (1) minute without any stirring. The remaining undissolved solids then are filtered out from the solution and immediately weighed (without drying). The Water Dissolvability is calculated as

$$\frac{Weight of Undissolved Solids}{10 grams} \times 100 \% .$$

As used herein, the term “Surfactant Activity” refers to the total weight percentage of surfactants in the laundry detergent sheet according to the present invention.

As used herein, the terms “consisting essentially of” means that the composition contains no ingredient that will interfere with benefits or functions of those ingredients that are explicitly disclosed. Further, the terms “essentially free of,” “substantially free of” or “substantially free from” means that the indicated material is present in the amount of from 0 wt % to about 1 wt %, or preferably from 0 wt % to about 0.5 wt %, or more preferably from 0 wt % to about 0.1 wt %, and most preferably it is not present at analytically detectable levels. The term “substantially pure” or “essentially pure” means that the indicated material is present in the amount of from about 99.5 wt % to about 100 wt %, preferably from about 99.9 wt % to about 100 wt %, and more preferably from 99.99 wt % to about 100 wt %, and most preferably all other materials are present only as impurities below analytically detectable levels.

As used herein, all concentrations and ratios are on a weight basis unless otherwise specified. All temperatures herein are in degrees Celsius (° C.) unless otherwise indicated. All conditions herein are at 20° C. and under the atmospheric pressure, unless otherwise specifically stated. All polymer molecular weights are determined by weight average number molecular weight unless otherwise specifically noted.

### Non-Fibrous Laundry Detergent Sheet

The laundry detergent sheet of the present invention is non-fibrous, i.e., it is free of or substantially free of fibrous elements. Such a laundry detergent sheet can be formed by first providing a slurry containing raw materials dissolved or dispersed in water, and then shaping the slurry into a sheet-like form. Drying is carried out either simultaneously with the shaping step, or it can be carried out subsequently, to remove water and form a finished sheet with little or no moisture content (e.g., approximately 3 wt % water or less).

The laundry detergent sheet of the present invention is completely or substantially water-soluble. In other words, it does not contain a water-insoluble substrate, as some of the conventional laundry detergent sheets do. The laundry detergent sheet of the present invention has a Water Dissolvability of at least 90%, preferably at least 95%, and more preferably at least 98%, and most preferably at least 99%, as measured according to the test method specified hereinafter. Preferably, the entire laundry detergent sheet of the present invention can be completely dissolved in a liter of deionized water, i.e., leaving no visible residue in the solution, within 15 seconds, more preferably within 10 seconds, and more preferably within 5 seconds, at 20° C. under atmospheric pressure and without any stirring.

The laundry detergent sheet of the present invention can have any shape or size, as long as its thickness, its length, and its width are characterized by a length-to-thickness aspect ratio of at least about 5:1, a width-to-thickness aspect ratio of at least about 5:1, and a length-to-width aspect ratio of at least about 1:1. Preferably, the length-to-thickness aspect ratio and the width-to-thickness aspect ratio are both at least about 10:1, and the length-to-width aspect ratio is at least about 1.2:1. More preferably, the length-to-thickness aspect ratio and the width-to-thickness aspect ratio are both at least about 15:1, and the length-to-width aspect ratio is at least about 1.5:1. Most preferably, the length-to-thickness aspect ratio and the width-to-thickness aspect ratio are both at least about 20:1, and the length-to-width aspect ratio is at least about 1.618:1. The thickness of the laundry detergent sheet of the present invention may range from about 0.1 mm to about 10 mm, preferably from about 0.2 mm to about 5 mm, more preferably from about 0.3 mm to about 4 mm, and most preferably from about 0.5 mm to about 2 mm. The width of the laundry detergent sheet may range from about 2 cm to about 1 meter, preferably from about 5 cm to about 50 cm, more preferably from about 10 cm to about 40 cm. The length of the laundry detergent sheet may range from about 2 cm to about 50 meters, preferably from about 5 cm to about 1 meter, and more preferably from about 10 cm to about 80 cm.

In a preferred but not necessary embodiment of the present invention, the laundry detergent sheet has a golden rectangular shape (i.e., with a length-to-width aspect ratio of about 1.618:1), and it is characterized by a width of about 10-15 cm and a thickness of about 0.5 mm to about 2 mm. Such a golden rectangular shape is aesthetically pleasing and delightful to the consumers, so multiple sheets of such shape can be stacked up and packaged together for sale in a container that is also characterized by a similar golden rectangular shape.

In an alternative embodiment of the present invention, the laundry detergent sheet has an elongated shape (i.e., with a length-to-width aspect ratio of about 10-50:1), and it is characterized by a width of about 10-15 cm and a thickness of about 0.5 mm to about 2 mm. Such elongated shape allows the laundry detergent sheet to be rolled up or folded into a compact unit for easy of packaging, storage, shipment and display.

The laundry detergent sheet of the present invention is characterized by a sufficiently high Surfactant Activity, e.g., at least 30%, preferably at least 50%, more preferably at least 60%, and most preferably at least 70%. Such high Surfactant Activity provides a very compact and concentrated form of laundry detergent, which is particularly convenient for consumers who travel often and need to do laundry on the road. Further, shipping and handling costs for such compact and concentrated form are significantly reduced, in comparison with the traditional powder or liquid forms of laundry detergents, which make this laundry detergent sheet particularly desirable to be marketed through e-commerce channels.

Preferably, the laundry detergent sheet of the present invention has certain attributes that render it aesthetically pleasing to the consumers. For example, the sheet may have a relatively smooth surface, thereby providing a pleasant feel when touched by the consumer. Further, it is desirable that the laundry detergent sheet may have little or no perceivable pores on its surface.

It is also desirable that the laundry detergent sheet of the present invention is strong to withstand substantive mechanical forces without losing its structural integrity, yet at the same time is sufficiently flexible for ease of packaging and storage.

### Printed Graphics Formed by Fabric Hueing Agent(s)

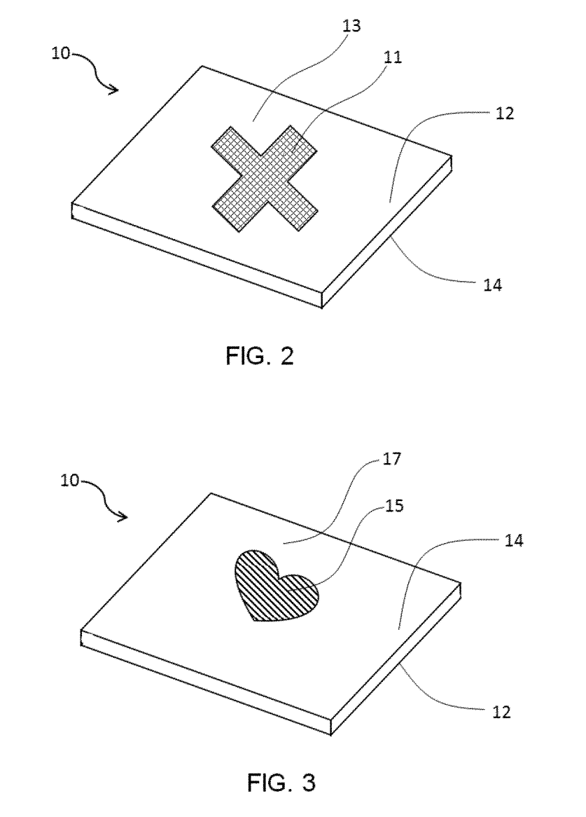

FIG. 2 shows a non-fibrous laundry detergent sheet 10 according to the present invention, which contains at least a first planar surface 12 and a second, opposite planar surface 14. The first and second planar surfaces 12 and 14 are preferably parallel to each other, while the distance between such first and second planar surfaces 12 and 14 defines the thickness of the non-fibrous laundry detergent sheet 12 as above mentioned.

The first planar surface 12 of the non-fibrous laundry detergent sheet 10 according to the present invention has at least one graphic pattern thereon that is formed by printing at least one fabric hueing agent. Such graphic pattern defines a discrete region 11 that visually contrasts with one or more surrounding discrete regions 13, which is either completely devoid of such fabric hueing agent, or contains it at a significantly lower concentration than region 11, or contains a different fabric hueing agent. Such a visual contrast can be qualitatively defined by a Color Contrast (ΔE) of at least about 2 between such discrete region 11 defined by the graphic pattern and the one or more surrounding discrete regions 13. The visual contrast between discrete region 11 and the surrounding discrete regions 13 allows the discrete region 11 to stand out visually to the consumers and makes a significant visual and aesthetic impression thereupon.

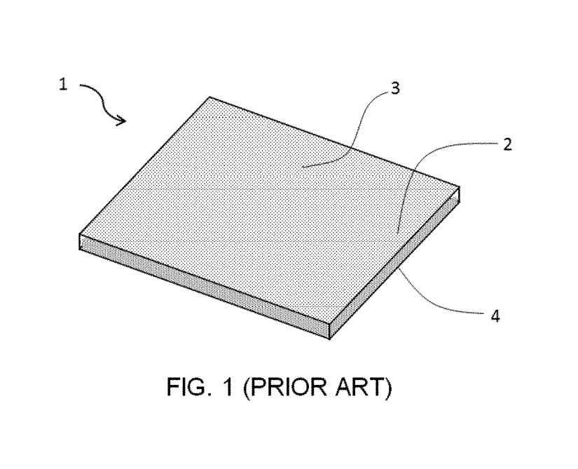

This is very different from a traditional non-fibrous laundry detergent sheet containing homogenously distributed or dispersed colorants, as shown in FIG. 1. Specifically, a traditional non-fibrous laundry detergent sheet 1 may contain a colorant 3 (not necessarily a fabric hueing agent) that is uniformly distributed or dispersed throughout, so from both of its two planar surfaces 2 and 4, an evenly distributed color is imparted by the colorant 3 and is observable by the consumers. When the colorant 3 is a fabric hueing agent, then the color imparted thereby is unavoidably affected by the shade and concentration of such fabric hueing agent, which may not be pleasing or desirable to the consumers.

By concentrating and localizing the fabric hueing agents into discrete regions to form graphic patterns on the non-fibrous laundry detergent sheets, the present provides a solution to the traditional problem associated with incorporation of hueing dyes into laundry detergent sheets. On one hand, such discrete graphic patterns containing the fabric hueing agents become aesthetic decorations themselves (instead of merely as a background color) on the laundry detergent sheets before use, thereby turning an aesthetic negative into an aesthetic positive and rendering such laundry detergent sheets more (instead of less) aesthetically pleasing to the consumers. On the other hand, the fabric hueing agents can now be freely dosed to provide the needed improved whiteness benefit to fabrics through treatment by the laundry detergent sheets.

Preferably, the Color Contrast (ΔE) between discrete regions 11 and 13 is at least about 2.3, more preferably at least about 3, still more preferably at least about 5, and most preferably at least about 6.

Preferably, the discrete region 11 has an area that is greater than about 1 cm² in area, preferably greater than about 2 cm², and more preferably greater than about 5 cm², and most preferably greater than about 10 cm². The one or more surrounding regions 13 preferably has an area that is greater than about 1 cm² in area, preferably greater than about 5 cm², and more preferably greater than about 10 cm², and most preferably greater than about 15 cm². The area of a specific discrete region is defined by continuous peripherals of such region, despite the fact that within such peripherals another discrete region of a different color may be present. For example, a discrete region A may be defined by a square graphic pattern with a fabric hueing agent, while within such square graphic pattern is another circular discrete region B that is devoid of such fabric hueing agent. The area of the discrete region A is then calculated based on the area of the square graphic pattern, without deducting the area of the circular discrete region B.

Further, the second, opposite planar surface 14 of the non-fibrous laundry detergent sheet 10 may also contain an additional graphic pattern thereon that is formed by printing the same or a different fabric hueing agent from what is used to print the graphic pattern on surface 12. Such additional graphic pattern defines another discrete region 15 that visually contrasts with one or more surrounding discrete regions 17, which is either completely devoid of the fabric hueing agent, or contains it at a significantly lower concentration than region 15, or contains a different fabric hueing agent. Such a visual contrast can also be qualitatively defined by a Color Contrast (ΔE) of at least 2 between discrete regions 15 and 17.

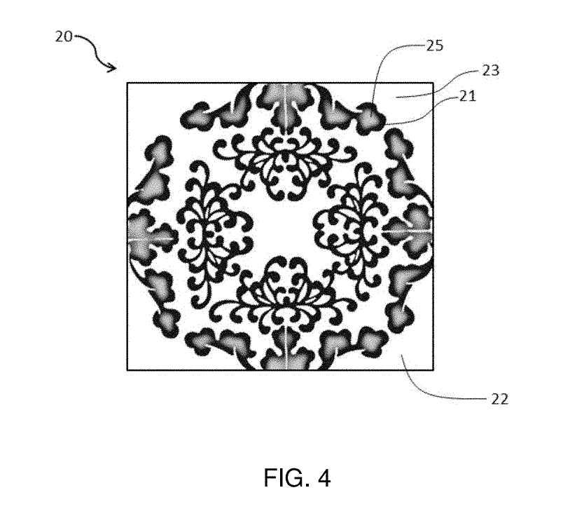

Still further, FIG. 4 shows another embodiment of a non-fibrous laundry detergent sheet 20 according to the present invention. Such sheet 20 has a planar surface 22 that contains a first discrete region 21 defined by a graphic pattern formed by a higher concentration of a fabric hueing agent, a second, surrounding discrete region 23 that is completely devoid of such fabric hueing agent, and a third discrete region 25 (inside the first discrete region 21) formed by either a lower concentration of the same fabric hueing agent or by another fabric hueing agent of a different color.

The shape and size of graphic patterns and the concentrations and colors of fabric hueing agents may vary widely and cannot be exhaustively illustrated herein, but all are within the spirit and scope of the present invention.

It is to be appreciated that the graphically printed non-fibrous laundry detergent sheets of the present invention may be used in various applications. In some embodiments, such sheets may be used to further form a pouch. For example, the graphically printed non-fibrous laundry detergent sheets may be configured to form a pouch wall material that forms one or more of the walls of a pouch such that an internal volume of the pouch is defined and enclosed, at least partially or entirely by the pouch wall material. In some applications, contents of the pouch, for example surfactants or other adjunct detergent ingredients in the form of powder, may be contained and retained in the internal volume of the pouch at least until the pouch ruptures, for example during use, to release its contents. Thus, the pouch wall material made from non-fibrous laundry detergent sheets herein may include a printed graphic that may be positioned on an internal and/or external wall surface of the pouch. A graphic positioned on an internal wall surface of a pouch is preferably configured to be visible from the external wall surface.

### Fabric Hueing Agent(s)

The fabric hueing agents used in the present invention may be any colorant that can be formulated into a laundry detergent composition to deposit onto fabrics from the wash liquor so as to improve fabric whiteness perception. The fabric hueing agent is typically blue or violet in color, and preferably such fabric hueing agent has a peak absorption wavelength of from about 550 nm to about 650 nm, or from about 570 nm to about 630 nm. In a specific embodiment, the fabric hueing agent may be a combination of colorants which together have the visual effect on the human eye as a single colorant having a peak absorption wavelength on polyester of from about 550 nm to about 650 nm, or from about 570 nm to about 630 nm. This may be provided for example by mixing a red colorant and a green-blue colorant to yield a blue or violet shade.

The fabric hueing agents may be selected from the group consisting of dyes, dye-clay conjugates, organic pigments, inorganic pigments and combinations thereof.

Dyes are typically coloured organic molecules which are soluble in aqueous media that contain surfactants (in contrast with pigments which are typically not soluble in aqueous media). Dyes may include small molecule dyes and polymeric dyes.

Suitable small molecule dyes maybe selected from the group consisting of direct dyes, basic dyes, reactive dyes, solvent dyes, disperse dyes, and combinations thereof. More preferably, suitable small molecular dyes may be selected from the group consisting of dyes falling into the Color Index (C.I.) classifications of Direct Blue, Direct Violet, Acid Blue, Acid Violet, Basic Blue, Basic Violet, and mixtures thereof. Examples of suitable dyes are violet DD, Direct Violet 7, Direct Violet 9, Direct Violet 11, Direct Violet 26, Direct Violet 31, Direct Violet 35, Direct Violet 40, Direct Violet 41, Direct Violet 51, Direct Violet 66, Direct Violet 99, Acid Violet 50, Acid Blue 9, Acid Violet 17, Acid Blue 29, Solvent Violet 13, Disperse Violet 27 Disperse Violet 26, Disperse Violet 28, Disperse Violet 63, Disperse Violet 77, Basic Blue 16, Basic Blue 65, Basic Blue 66, Basic Blue 67, Basic Blue 71, Basic Blue 159, Basic Violet 19, Basic Violet 35, Basic Violet 38, Basic Violet 48, Basic Blue 3, Basic Blue 75, Basic Blue 95, Basic Blue 122, Basic Blue 124, Basic Blue 141, Reactive Blue 19, Reactive Blue 163, Reactive Blue 182, Reactive Blue 96, thiazolium dyes, Liquitint® Violet CT (Milliken, Spartanburg, USA) and Azo-CM-Cellulose (Megazyme, Bray, Republic of Ireland). Other suitable hueing agents are hueing dye-photobleach conjugates, such as the conjugate of sulphonated zinc phthalocyanine with Direct Violet 99. A particularly suitable hueing agent is a combination of Acid Red 52 and Acid Blue 80, or the combination of Direct Violet 9 and Solvent Violet 13.

In a particularly preferred embodiment of the present invention, the fabric hueing agent has the following structure:

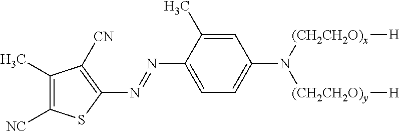

wherein the index values x and y are independently selected from 1 to 10.

In another preferred embodiment of the present invention, the fabric hueing agent has the following structure:

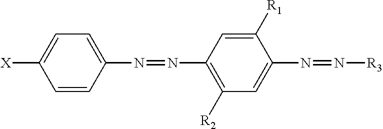

wherein: R₁ and R₂ are independently selected from the group consisting of: H; alkyl; alkoxy; alkyleneoxy; alkyl capped alkyleneoxy; urea; and amido; R₃ is a substituted aryl group; X is a substituted group comprising sulfonamide moiety and optionally an alkyl and/or aryl moiety, and wherein the substituent group comprises at least one alkyleneoxy chain that comprises an average molar distribution of at least four alkyleneoxy moieties.

Fluorescent dyes are another group of dyes that can be used to achieve fabric hueing benefit, either alone or in combination with the dyes described hereinabove. Suitable fluorescent dyes include, but are not limited to: diaminostilbenes, distyrylbiphenyls, and combinations thereof. Preferably, such fluorescent dyes are selected from the group consisting of disodium 4,4′-bis{[4-anilino-6-morpholino-s-triazin-2-yl]-amino}-2,2′-stilbenedisulfonate (also referred to as “Fluorescent Brightener 260”), disodium 4,4″-bis[(4,6-di-anilino-s-triazin-2-yl)-amino]-2,2′-stilbenedisulfonate, disodium 4,4′-bis{[4-anilino-6-[bis(2-hydroxyethyl)amino-s-triazin-2-yl] amino}-2,2′-stilbenedisulfonate, disodium 2,2′-([1,1′-biphenyl]-4,4′diyldivinylene)bis (benzenesulphonate) (also referred to as “Fluorescent Brightener 351”), and combinations thereof. The fluorescent dyes may be in micronized particulate form, having a weight average particle size in the range of from 3 to 30 micrometers, or from 3 micrometers to 20 micrometers, or from 3 to 10 micrometers. The brightener can be alpha or beta crystalline form.

The amount of fabric hueing agents used in the non-fibrous laundry detergent sheet of the present invention may range from about 0.01% to about 1.2% by total weight of such non-fibrous laundry detergent sheet. However, instead of mixing all this amount of fabric hueing agent into the base sheet itself, it is first formulated into a printing ink mixture and then printed onto one or both planar surfaces of the non-fibrous laundry detergent sheet to form visually distinctive graphic patterns thereon.

### Surfactants

The non-fibrous laundry detergent sheet of the present invention may comprise at least one surfactant selected from the group consisting of anionic surfactants, nonionic surfactants, amphoteric surfactants, cationic surfactants, and combinations thereof. Such at least one surfactant form a surfactant system in the non-fibrous laundry detergent sheet, which can be present in an amount ranging from about 5% to about 90%, preferably from about 10% to about 90%, more preferably from about 20% to about 90%, still more preferably from about 30% to about 90%, and most preferably from about 50% to about 90%, by total weight of the non-fibrous laundry detergent sheet.

In a particularly preferred but not necessary embodiment of the present invention, the laundry detergent sheet may have a surfactant system containing only anionic surfactants, e.g., either a single anionic surfactant or a combination of two or more different anionic surfactants. Alternatively, the laundry detergent sheet of the present invention may have a composite surfactant system, e.g., containing a combination of one or more anionic surfactants with one or more nonionic surfactants, or a combination of one or more anionic surfactants with one or more amphoteric surfactants, or a combination of one or more anionic surfactants with one or more cationic surfactants, or a combination of all the above-mentioned types of surfactants (i.e., anionic, nonionic, amphoteric and cationic). Preferably but not necessarily, the laundry detergent sheet of the present invention has a composite surfactant system containing a combination of one or more anionic surfactants with one or more nonionic surfactants.

### Anionic Surfactants

Anionic surfactants suitable for forming the laundry detergent sheet of the present invention can be readily selected from the group consisting of C₆-C₂₀ linear or branched alkyl benzene sulfonates (LAS), C₆-C₂₀ linear or branched alkyl sulfates (AS), C₆-C₂₀ linear or branched alkyl alkoxylated sulfates (AAS), C₆-C₂₀ linear or branched alkyl sulfonates, C₆-C₂₀ linear or branched alkyl carboxylates, C₆-C₂₀ linear or branched alkyl phosphates, C₆-C₂₀ linear or branched alkyl phosphonates, and combinations thereof. Preferred anionic surfactants of the present invention are selected from the group consisting of LAS, AS, AAS, and combinations thereof. The total amount of anionic surfactants in the laundry detergent sheet may range from 5% to 90%, preferably from 10% to 80%, more preferably from 20% to 75%, and most preferably from 30% to 70%, by total weight of the non-fibrous laundry detergent sheet.

### Mid-Cut AS

A particularly preferred type of anionic surfactants for forming the non-fibrous laundry detergent sheet of the present invention are C₆-C₁₈ alkyl sulfates, which are referred to as “mid-cut AS” hereinafter, while each of which has a branched or linear unalkoxylated alkyl group containing from about 6 to about 18 carbon atoms. In a particularly preferred embodiment of the present invention, the mid-cut AS is present as the main surfactant in the laundry detergent sheet, i.e., it is present in an amount that is greater than 50% by total weight of all surfactants in said sheet, while other anionic surfactants (such as LAS and/or AAS) are present as co-surfactants for such mid-cut AS.

The mid-cut AS of the present invention has the generic formula of R—O—SO₃⁻M⁺, while R is branched or linear unalkoxylated C₆-C₁₈ alkyl group, and M is a cation of alkali metal, alkaline earth metal or ammonium. Preferably, the R group of the AS surfactant contains from about 8 to about 16 carbon atoms, more preferably from about 10 to about 14 carbon atoms, and most preferably from about 12 to about 14 carbon atoms. R can be substituted or unsubstituted, and is preferably unsubstituted. R is substantially free of any alkoxylation. M is preferably a cationic of sodium, potassium, or magnesium, and more preferably M is a sodium cation.

Such mid-cut AS surfactant(s) preferably functions as the main surfactant in the surfactant system of the non-fibrous laundry detergent sheet of the present invention. In other words, the mid-cut AS surfactant(s) are present in an amount of greater than 50% by total weight of all surfactants in the laundry detergent sheet.

Preferably, but not necessarily, the surfactant system of the present invention contains a mixture of mid-cut AS surfactants, in which C₆-C₁₄ AS surfactants are present in an amount ranging from about 85% to about 100% by total weight of the mixture. This mixture can be referred to as a “C₆-C₁₄-rich AS mixture.” More preferably, such C₆-C₁₄-rich AS mixture contains from about 90 wt % to about 100 wt %, or from 92 wt % to about 98 wt %, or from about 94 wt % to about 96 wt %, or 100 wt % (i.e., pure), of C₆-C₁₄ AS.

In a particularly preferred embodiment of the present invention, the surfactant system contains a mixture of mid-cut AS surfactants comprising from about 30 wt % to about 100 wt % or from about 50 wt % to about 99 wt %, preferably from about 60 wt % to about 95 wt %, more preferably from about 65 wt % to about 90 wt %, and most preferably from about 70 wt % to about 80 wt % of C₁₂-C₁₄ AS, which can be referred to as a “C₁₂-C₁₄-rich AS mixture.” Preferably, such C₁₂-C₁₄-rich AS mixture contains a majority of C₁₂ AS. In a most preferred embodiment of the present invention, the surfactant system contains a mixture of mid-cut AS surfactants that consist of C₁₂ and/or C₁₄ AS surfactants, e.g., 100% C₁₂ AS or from about 70 wt % to about 80 wt % of C₁₂ AS and from 20 wt % to about 30 wt % of C₁₄ AS, with little or no other AS surfactants therein.

A commercially available mid-cut AS mixture particularly suitable for practice of the present invention is Texapon® V95 G from Cognis (Monheim, Germany).

Further, the surfactant system of the present invention may contain a mixture of mid-cut AS surfactants comprising more than about 50 wt %, preferably more than about 60 wt %, more preferably more than 70 wt % or 80 wt %, and most preferably more than 90 wt % or even at 100 wt % (i.e., substantially pure), of linear AS surfactants having an even number of carbon atoms, including, for example, C₆, C₈, C₁₀, C₁₂, C₁₄, C₁₆, and C₁₈ AS surfactants.

The amount of mid-cut AS surfactants used in the present invention may range from about 5% to about 90%, preferably from about 10% to about 80%, more preferably from about 20% to about 75%, and most preferably from about 30% to about 70%, by total weight of the non-fibrous laundry detergent sheet. In a most preferred embodiment of the present invention, the non-fibrous laundry detergent sheet contains from about 10 wt % to about 60 wt %, preferably from about 20 wt % to about 50 wt %, of pure C₁₂ AS or a C₁₂-C₁₄-rich AS mixture by total weight of such sheet, while the C₁₂-C₁₄-rich AS mixture contains from about 70 wt % to about 80 wt % of C₁₂ AS and from 20 wt % to about 30 wt % of C₁₄ AS by total weight of such mixture.

### LAS

The non-fibrous laundry detergent sheet of the present invention may contain, either alone as a main surfactant, or preferably in combination with the mid-cut AS described hereinabove as its co-surfactant, a C₆-C₂₀ linear alkylbenzene sulfonate (LAS). In a particularly preferred embodiment of the present invention, LAS is present as the main surfactant in the laundry detergent sheet, i.e., it is present in an amount that is greater than 50% by total weight of all surfactants in said sheet, while other anionic surfactants (such as mid-cut AS and/or AAS) are present as co-surfactants for such LAS.

LAS anionic surfactants are well known in the art and can be readily obtained by sulfonating commercially available linear alkylbenzenes. Exemplary C₆-C₂₀ linear alkylbenzene sulfonates that can be used in the present invention include alkali metal, alkaline earth metal or ammonium salts of C₆-C₂₀ linear alkylbenzene sulfonic acids, and preferably the sodium, potassium, magnesium and/or ammonium salts of C₁₁-C₁₈ or C₁₁-C₁₄ linear alkylbenzene sulfonic acids. More preferred are the sodium or potassium salts of C₁₂ linear alkylbenzene sulfonic acids, and most preferred is the sodium salt of C₁₂ linear alkylbenzene sulfonic acid, i.e., sodium dodecylbenzene sulfonate.

If present, the amount of LAS in the non-fibrous laundry detergent sheet of the present invention may range from about 5% to about 90%, preferably from about 10% to about 80%, more preferably from about 20% to about 75%, and most preferably from about 30% to about 70%, by total weight of the laundry detergent sheet. In a most preferred embodiment of the present invention, the non-fibrous laundry detergent sheet contains from about 5 wt % to about 20 wt % of a sodium, potassium, or magnesium salt of C₁₂ linear alkylbenzene sulfonic acid.

### AAS

The non-fibrous laundry detergent sheet of the present invention may contain, either alone as a main surfactant, or preferably in combination with the mid-cut AS and/or LAS described hereinabove as a co-surfactant, a C₁₀-C₂₀ linear or branched alkylalkoxy sulfate (AAS) having an average degree of alkoxylation ranging from about 0.1 to about 5.

The AAS surfactants preferably are C₁₀-C₂₀ linear or branched alkylethoxy sulfate (AES) with the following formula (I):

R—O—(C₂H₄O)ₓ—SO₃⁻M⁺ (I),

wherein R is a linear or branched alkyl chain having from 10 to 20 carbon atoms, either saturated or unsaturated; x averages from 1 to 3; and M is selected from the group consisting of alkali metal ions, ammonium, or substituted ammonium. Preferably, R is a linear or branched alkyl chain having from 12 to 16 carbon atoms; x averages 3; and M is sodium. The most preferred anionic surfactant for the practice of the present invention is sodium lauryl ether sulphate with an average degree of ethoxylation of about 3.

The AAS surfactants, if present, can be provided in an amount ranging from about 1% to about 30%, preferably from about 2% to about 20%, more preferably from about 5% to about 15%, by total weight of the non-fibrous laundry detergent sheet.

### Nonionic Surfactants

The non-fibrous laundry detergent sheet of the present invention may contain one or more nonionic surfactants, which are to be used in combination with the anionic surfactants described hereinabove. Such nonionic surfactant(s) may be present in an amount ranging from 1% to 40%, preferably from 2% to 30%, more preferably from 5% to 25%, and most preferably from 10% to 20%, by total weight of such non-fibrous laundry detergent sheet.

Suitable nonionic surfactants useful herein can comprise any conventional nonionic surfactant. These can include, for e.g., amine oxide surfactants and alkoxylated fatty alcohols. The nonionic surfactants may be selected from the ethoxylated alcohols and ethoxylated alkyl phenols of the formula R(OC₂H₄)ₙOH, wherein R is selected from the group consisting of aliphatic hydrocarbon radicals containing from about 8 to about 15 carbon atoms and alkyl phenyl radicals in which the alkyl groups contain from about 8 to about 12 carbon atoms, and the average value of n is from about 5 to about 15. In one example, the nonionic surfactant is selected from ethoxylated alcohols having an average of about 24 carbon atoms in the alcohol and an average degree of ethoxylation of about 9 moles of ethylene oxide per mole of alcohol. Other non-limiting examples of nonionic surfactants useful herein include: C₈-C₁₈ alkyl ethoxylates, such as, NEODOL® nonionic surfactants from Shell; C₆-C₁₂ alkyl phenol alkoxylates where the alkoxylate units may be ethyleneoxy units, propyleneoxy units, or a mixture thereof; C₁₂-C₁₈ alcohol and C₆-C₁₂ alkyl phenol condensates with ethylene oxide/propylene oxide block polymers such as Pluronic® from BASF; C₁₄-C₂₂ mid-chain branched alcohols; C₁₄-C₂₂ mid-chain branched alkyl alkoxylates, BAEₓ, wherein x is from 1 to 30; alkylpolysaccharides, and specifically alkylpolyglycosides; polyhydroxy fatty acid amides; and ether capped poly(oxyalkylated) alcohol surfactants. Suitable nonionic surfactants also include those sold under the tradename Lutensol® from BASF.

Preferred nonionic surfactants of the present invention include alkyl polyglucoside, alkyl alcohols, alkyl alkoxylated alcohols, alkyl alkoxylates, alkyl phenol alkoxylates, alkylcelluloses, polyhydroxy fatty acid amides, ether capped poly(oxyalkylated) alcohol surfactants. In a more preferred embodiment, the nonionic surfactant is selected from alkyl alkoxylated alcohols, such as a C₈₋₁₈ alkyl alkoxylated alcohol, and more specifically a C₈₋₁₈ alkyl ethoxylated alcohol. The alkyl alkoxylated alcohol may have an average degree of alkoxylation of from about 1 to about 50, or from about 1 to about 30, or from about 1 to about 20, or from about 1 to about 10. The alkyl alkoxylated alcohol can be linear or branched, substituted or unsubstituted.

In a most preferred embodiment, the non-fibrous laundry detergent sheet of the present invention contains a C₁₂₋₁₄ alkyl ethoxylated alcohol having an average degree of ethoxylation of from about 1 to about 10, or from about 1 to about 8, or from about 3 to about 7, in an amount ranging from about 1% to about 40%, preferably from about 5% to about 25%, and more preferably from about 10% to about 20%, by total weight of the laundry detergent sheet.

### Adjunct Detergent Ingredients

The non-fibrous laundry detergent sheet of the present invention may optionally include one or more other adjunct detergent ingredients for assisting or enhancing cleaning performance or to modify the aesthetics of the sheet. Illustrative examples of such adjunct detergent ingredients include: (1) inorganic and/or organic builders, such as carbonates (including bicarbonates and sesquicarbonates), sulphates, phosphates (exemplified by the tripolyphosphates, pyrophosphates, and glassy polymeric meta-phosphates), phosphonates, phytic acid, silicates, zeolite, citrates, polycarboxylates and salts thereof (such as mellitic acid, succinic acid, oxydisuccinic acid, polymaleic acid, benzene 1,3,5-tricarboxylic acid, carboxymethyloxysuccinic acid, and soluble salts thereof), ether hydroxypolycarboxylates, copolymers of maleic anhydride with ethylene or vinyl methyl ether, 1,3,5-trihydroxy benzene-2,4,6-trisulphonic acid, 3,3-dicarboxy-4-oxa-1,6-hexanedioates, polyacetic acids (such as ethylenediamine tetraacetic acid and nitrilotriacetic acid) and salts thereof, fatty acids (such as C₁₂-C₁₈ monocarboxylic acids); (2) chelating agents, such as iron and/or manganese-chelating agents selected from the group consisting of amino carboxylates, amino phosphonates, polyfunctionally-substituted aromatic chelating agents and mixtures therein; (3) clay soil removal/anti-redeposition agents, such as water-soluble ethoxylated amines (particularly ethoxylated tetraethylene-pentamine); (4) polymeric dispersing agents, such as polymeric polycarboxylates and polyethylene glycols, acrylic/maleic-based copolymers and water-soluble salts thereof of, hydroxypropylacrylate, maleic/acrylic/vinyl alcohol terpolymers, polyethylene glycol (PEG), polyaspartates and polyglutamates; (5) optical brighteners, which include but are not limited to derivatives of stilbene, pyrazoline, coumarin, carboxylic acid, methinecyanines, dibenzothiphene-5,5-dioxide, azoles, 5- and 6-membered-ring heterocycles, and the like; (6) suds suppressors, such as monocarboxylic fatty acids and soluble salts thereof, high molecular weight hydrocarbons (e.g., paraffins, haloparaffins, fatty acid esters, fatty acid esters of monovalent alcohols, aliphatic C₁₈-C₄₀ ketones, etc.), N-alkylated amino triazines, propylene oxide, monostearyl phosphates, silicones or derivatives thereof, secondary alcohols (e.g., 2-alkyl alkanols) and mixtures of such alcohols with silicone oils; (7) suds boosters, such as C₁₀-C₁₆ alkanolamides, C₁₀-C₁₄ monoethanol and diethanol amides, high sudsing surfactants (e.g., amine oxides, betaines and sultaines), and soluble magnesium salts (e.g., MgCl₂, MgSO₄, and the like); (8) fabric softeners, such as smectite clays, amine softeners and cationic softeners; (9) dye transfer inhibiting agents, such as polyvinyl pyrrolidone polymers, polyamine N-oxide polymers, copolymers of N-vinylpyrrolidone and N-vinylimidazole, manganese phthalocyanine, peroxidases, and mixtures thereof; (10) enzymes, such as proteases, amylases, lipases, cellulases, and peroxidases, and mixtures thereof; (11) enzyme stabilizers, which include water-soluble sources of calcium and/or magnesium ions, boric acid or borates (such as boric oxide, borax and other alkali metal borates); (12) bleaching agents, such as percarbonates (e.g., sodium carbonate peroxyhydrate, sodium pyrophosphate peroxyhydrate, urea peroxyhydrate, and sodium peroxide), persulfates, perborates, magnesium monoperoxyphthalate hexahydrate, the magnesium salt of metachloro perbenzoic acid, 4-nonylamino-4-oxoperoxybutyric acid and diperoxydodecanedioic acid, 6-nonylamino-6-oxoperoxycaproic acid, and photoactivated bleaching agents (e.g., sulfonated zinc and/or aluminum phthalocyanines); (13) bleach activators, such as nonanoyloxybenzene sulfonate (NOBS), tetraacetyl ethylene diamine (TAED), amido-derived bleach activators including (6-octanamidocaproyl)oxybenzenesulfonate, (6-nonanamidocaproyl)oxybenzenesulfonate, (6-decanamidocaproyl)oxybenzenesulfonate, and mixtures thereof, benzoxazin-type activators, acyl lactam activators (especially acyl caprolactams and acyl valerolactams); and (14) any other known detergent adjunct ingredients, including but not limited to carriers, hydrotropes, processing aids, dyes or pigments, and solid fillers.

### Film Former

The non-fibrous laundry detergent sheet of the present invention contains, in addition to the surfactant(s) described and adjunct detergent ingredients described hereinabove, at least one film former. Such at least one film former can be selected from water-soluble polymers, either synthetic or natural in origin and may be chemically and/or physically modified.

Suitable examples of water-soluble polymers for the practice of the present invention include polyalkylene glycols (also referred to as polyalkylene oxides or polyoxyalkylenes), polyvinyl alcohols, polysaccharides (such as starch or modified starch, cellulose or modified cellulose, pullulan, xanthum gum, guar gum, and carrageenan), polyacrylates, polymethacrylates, polyacrylamides, polyvinylpyrrolidones, and proteins/polypeptides or hydrolyzed products thereof (such as collagen and gelatin). Preferably, the film former to be used in the present invention is selected from the group consisting of polyalkylene glycols, polyvinyl alcohols, starch or modified starch, cellulose or modified cellulose, polyacrylates, polymethacrylates, polyacrylamides, polyvinylpyrrolidones, and combinations thereof. In a particularly preferred embodiment of the present invention, the non-fibrous laundry detergent sheet contains a polyethylene glycol (PEG) or a polyvinyl alcohol (PVA), either alone (i.e., without other film formers) or in combination with a polystarch, modified starch, cellulose, or modified cellulose.

In the execution of PEG, the PEG may be selected from poly(ethylene glycol) homopolymers and poly(ethylene glycol) copolymers having a weight average molecular weight of between about 2,000 and about 100,000 g/mol, preferably between about 4,000 and about 90,000 g/mol, and more preferably between about 6,000 and about 8,000 g/mol. Suitable poly(ethylene glycol) copolymers preferably contain at least about 50 wt % of PEG and may be selected from the group consisting of poly(lactide-block-ethylene glycol), poly(glycolide-block-ethylene glycol), poly(lactide-co-caprolactone)-block-poly(ethylene glycol), poly(ethylene glycol-co-lactic acid), poly(ethylene glycol-co-glycolic acid), poly(ethylene glycol-co-poly(lactic acid-co-glycolic acid), poly(ethylene glycol-co-propylene glycol), poly(ethylene oxide-block-propylene oxide-block-ethylene oxide), poly(propylene oxide-block-ethylene glycol-block-propylene glycol), and poly(ethylene glycol-co-caprolactone). Exemplary poly(ethylene glycol) homopolymers are commercially available from Sigma Aldrich, or from Dow under the tradename of CARBOWAX™, or from BASF under the tradename of Pluriol®. Exemplary poly(ethylene glycol) copolymers are commercially available from BASF under the tradenames of Pluronic® F127, Pluronic® F108, Pluronic® F68 and Pluronic® P105. A particularly preferred PEG for the practice of the present invention is a poly(ethylene glycol) homopolymer having a weight average molecular weight of between about 6,000 and about 80,000 g/mol.

In the execution of PVA, the PVA may be unmodified or modified, e.g., carboxylated or sulfonated. Preferably, the PVA is partially or fully alcoholised or hydrolysed. For example it may be from 40 to 100%, preferably 70 to 92%, more preferably 88% to 92%, alcoholised or hydrolysed. The degree of hydrolysis is known to influence the temperature at which the PVA starts to dissolve in water, e.g., 88% hydrolysis corresponds to a PVA film soluble in cold (i.e. room temperature) water, whereas 92% hydrolysis corresponds to a PVA film soluble in warm water. An example of preferred PVA is ethyoxylated PVA. A more preferred example of PVA is commercially available from Sekisui Specialty Chemicals America, LLC (Dallas, Tex.) under the tradename CELVOL®. Another more preferred example of PVA is the so-called G Polymer commercially available Nippon Ghosei.

The film former may be present in the non-fibrous laundry detergent sheet of the present invention at from about 1% to about 70%, preferably from about 2% to about 60%, more preferably from about 5% to about 50%, and most preferably from about 10% to about 40%, by total weight of the sheet.

In addition to the film former, the non-fibrous laundry detergent sheet may also comprise suitable additives such as plasticizers and solids, for modifying the properties of the film former. Suitable plasticizers are, for example, pentaerythritols such as depentaerythritol, sorbitol, mannitol, glycerine and glycols such as glycerol or ethylene glycol. Plasticizers are generally used in an amount of up to 35 wt %, for example from 5 to 35 wt %, preferably from 7 to 20 wt %, more preferably from 10 to 15 wt %. Solids such as talc, stearic acid, magnesium stearate, silicon dioxide, zinc stearate or colloidal silica may also be used, generally in an amount ranging from about 0.5 to 5 wt %.

### Process of Making the Non-Fibrous Laundry Detergent Sheet

The non-fibrous laundry detergent sheet can be made by any suitable film-forming method, such as casting, molding, pressing, extrusion/extrusion-coating, calendar rolling, solution deposition, skiving, and lamination. For example, it can be formed by first providing a slurry containing raw materials dissolved or dispersed in water, and then shaping the slurry into a sheet-like form. Drying is carried out either simultaneously with the shaping step, or it can be carried out subsequently, to remove water and form a finished sheet with little or no moisture content (e.g., less than 3 wt % water).

A preferred but non-limiting process for making the non-fibrous laundry detergent sheet of the present invention by using a cylinder sheet production system is described hereinafter.

The cylinder sheet production system comprises a base bracket with a heated rotatable cylinder installed thereon. The heated rotatable cylinder can be driven by a motorized drive installed on the base bracket, and work at a predetermined rotation speed. Said heated rotatable cylinder is preferably coated with a non-stick coating on its outer surface.

There is also provided a feeding mechanism on the base bracket, which is for adding a pre-formed slurry containing all or some raw materials described hereinabove (e.g., the surfactant(s), the film former(s), and adjunct detergent ingredients) onto the heated rotatable cylinder. The feeding mechanism includes a feeding rack installed on the base bracket, while said feeding rack has installed thereupon at least one (preferably two) feeding hopper(s), an imaging device for dynamic observation of the feeding, and an adjustment device for adjusting the position and inclination angle of the feeding hopper.

There is also a heating shield installed on the base bracket, to prevent rapid heat lost. Otherwise, the slurry can solidify too quickly on the heated rotatable cylinder. The heating shield can also effectively save energy needed by the heated rotatable cylinder, thereby achieving reduced energy consumption and provide cost savings. The heating shield is a modular assembly structure, or integrated structure, and can be freely detached from the base bracket. A suction device is also installed on the heating shield for sucking the hot steam, to avoid any water condensate falling on the laundry detergent sheet that is being formed. There is also a start feeding mechanism installed on the base bracket, which is for scooping up the laundry detergent sheet already formed by the heated rotatable cylinder.

The making process of the non-fibrous laundry detergent sheet is as follows. Firstly, the heated rotatable cylinder with the non-stick coating on the base bracket is driven by the motorized drive. Next, the adjustment device adjusts the feeding mechanism so that the distance between the feeding hopper and the outer surface of the heated rotatable cylinder reaches a preset value. Meanwhile, the feeding hopper adds the pre-formed slurry containing all or some raw materials for making the non-fibrous laundry detergent sheet onto the heated rotatable cylinder. The suction device of the heating shield sucks the hot steam generated by the heated rotatable cylinder.

Next, the start feeding mechanism scoops up the dried laundry detergent sheet. The already formed laundry detergent sheet can then be sliced or cut into desired sizes by a slicing/cutting device downstream of the heated rotatable cylinder. Optionally, it is further embossed with lines, patterns, logos, etc. by an embossing device downstream of the heated rotatable cylinder.

### Printing Process

The graphic patterns as mentioned hereinabove can be formed on an already formed non-fibrous laundry detergent sheet by a printing method selected from the group consisting of letterpress printing, lithographic printing, rotogravure printing, offset printing, screen printing, flexographic printing, inkjet printing, laser printing, 3D-printing, and the like, which are known in the art for printing. Preferably, the printing method is selected from the group consisting of flexographic printing, inkjet printing, and, laser printing. More preferably, the printing method is a digital printing process selected from inkjet printing or laser printing.

Specifically, the above-described fabric hueing agent(s) is mixed with one or more non-aqueous solvents and optionally other colorants, resins, additives, etc., to form a solvent-based ink mixture, either in form of a paste or powder. Such a solvent-based ink mixture is then fed to a printing device to carry out the above-mentioned printing step. Non-aqueous solvents are preferred in this invention (over water), because the non-fibrous laundry detergent sheet is water-soluble, so aqueous ink mixture, if not carefully applied, may compromise the structural integrity of the sheet during printing. However, aqueous ink mixture may still be employed, as long as the printing process is executed in a manner so as to minimize any adverse structural impact on the non-fibrous laundry detergent sheet.

In a specific embodiment of the present invention, the printing device is an inkjet printer. Inkjet printing is a non-impact dot-matrix printing technology in which droplets of ink are jetted from a small aperture directly to a specific position on a media to create a graphic. Two examples of inkjet technologies include thermal bubble (or bubble jet) and piezoelectric.

In another specific embodiment of the present invention, the printing device is a laser printer. Laser printing is an electrostatic digital printing process using electrically charged powdered ink. In this embodiment, the fabric hueing agent needs to be formulated into the powdered ink particles.

In another specific embodiment of the present invention, the printing device is a flexographic printer. Flexographic printing is a direct rotary printing method, which uses flexible printing plates generally made of rubber or plastic. The printing plates, with a slightly raised printing area, are rotated on a cylindrical forming a design roll which transfers the image formed by a viscous printing mixture to a substrate.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A non-fibrous laundry detergent sheet having a first planar surface and a second, opposite planar surface, wherein said first planar surface comprises a first discrete region and a second discrete region that are characterized by a Color Contrast (ΔE) of at least 2, wherein the first discrete region and/or the second discrete region comprises one or more fabric hueing agents selected from the group consisting of dyes, dye-clay conjugates, organic pigments, inorganic pigments and combinations thereof, wherein said laundry detergent sheet comprises at least one surfactant and at least one film former, wherein said laundry detergent sheet is completely or substantially water-soluble, wherein said laundry detergent sheet has a thickness ranging from 0.1 mm to 10 mm, a length-to-thickness aspect ratio of at least 5:1, and a width-to-thickness aspect ratio of at least 5:1.

2. The non-fibrous laundry detergent sheet of claim 1, wherein the Color Contrast (ΔE) between the first and second discrete regions is at least 2.3, preferably at least 3, more preferably at least 5, and most preferably at least 6.

3. The non-fibrous laundry detergent sheet of claim 1, wherein said one or more fabric hueing agents comprise one or more dyes selected from the group consisting of direct dyes, basic dyes, reactive dyes, solvent dyes, disperse dyes, and combinations thereof.

4. The non-fibrous laundry detergent sheet of claim 1, wherein said one or more fabric hueing agents comprise one or more dyes having the following chemical structures: 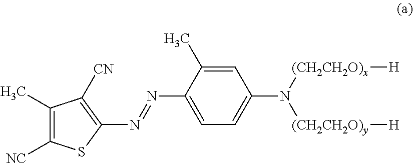
wherein the index values x and y are independently selected from 1 to 10; and/or 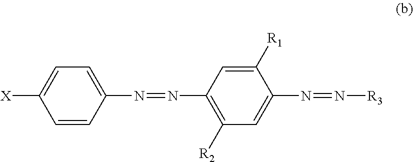
wherein: R1 and R2 are independently selected from the group consisting of: H; alkyl; alkoxy; alkyleneoxy; alkyl capped alkyleneoxy; urea; and amido; R3 is a substituted aryl group; X is a substituted group comprising sulfonamide moiety and optionally an alkyl and/or aryl moiety, and wherein the substituent group comprises at least one alkyleneoxy chain that comprises an average molar distribution of at least four alkyleneoxy moieties.

5. The non-fibrous laundry detergent sheet according to claim 1, wherein said one or more fabric hueing agents comprises one or more fluorescent dyes selected from the group consisting of diaminostilbenes, distyrylbiphenyls, and combinations thereof, and more preferably said one or more fluorescent dyes are selected from the group consisting of disodium 4,4′-bis{[4-anilino-6-morpholino-s-triazin-2-yl]-amino}-2,2′-stilbenedisulfonate, disodium 4,4″-bis[(4,6-di-anilino-s-triazin-2-yl)-amino]-2,2′-stilbenedisulfonate, disodium 4,4′-bis{[4-anilino-6-[bis(2-hydroxyethyl)amino-s-triazin-2-yl]-amino}-2,2′-stilbenedisulfonate, disodium 2,2′-([1,1′-biphenyl]-4,4′-diyldivinylene)bis(benzenesulphonate), and combinations thereof.

6. The non-fibrous laundry detergent sheet according to claim 1, wherein only one of said first and second discrete regions comprises said one or more fabric hueing agents, wherein the other of said first and second discrete regions is either substantially free of any fabric hueing agents or comprises one or more different fabric hueing agents.

7. The non-fibrous laundry detergent sheet according to claim 1, wherein the second planar surface comprises a third discrete region and a fourth discrete region that are also characterized by a Color Contrast (ΔE) of at least 2, wherein the third discrete region and/or the fourth discrete region also comprises said one or more fabric hueing agents.

8. The non-fibrous laundry detergent sheet according to claim 1, wherein said at least one surfactant is present in an amount ranging from 5% to 90%, preferably from 20% to 90%, more preferably from 30% to 90%, and most preferably from 50% to 90%, by total weight of such non-fibrous laundry detergent sheet.

9. The non-fibrous laundry detergent sheet according to claim 1, comprising one or more anionic surfactants selected from the group consisting of C₆-C₂₀ linear alkylbenzene sulfonates (LAS), C₆-C₂₀ linear or branched alkyl sulfates (AS), C₆-C₂₀ linear or branched alkylalkoxy sulfates (AAS) having a weight average degree of alkoxylation ranging from 0.1 to 10, and combinations thereof.

10. The non-fibrous laundry detergent sheet according to claim 1, comprising: (1) one or more C₆-C₁₈ linear or branched AS surfactants as the main surfactant(s); and (2) one or more C₆-C₂₀ LAS and/or C₆-C₂₀ linear or branched AAS as co-surfactant(s), wherein said main surfactant(s) are present in an amount that is greater than 50% by total weight of all surfactants in said sheet, and wherein said one or more C₆-C₁₈ linear or branched AS surfactants are preferably C₁₂-C₁₄ linear or branched AS surfactants.

11. The non-fibrous laundry detergent sheet according to claim 1, comprising: (1) one or more C₆-C₂₀ LAS surfactants as the main surfactant(s); and (2) one or more C₆-C₁₈ linear or branched AS and/or C₆-C₂₀ linear or branched AAS as co-surfactant(s), wherein said main surfactant(s) are present in an amount that is greater than 50% by total weight of all surfactants in said sheet.

12. The non-fibrous laundry detergent sheet according to claim 1, further comprising one more nonionic surfactants in an amount ranging from 1% to 40%, preferably from 2% to 30%, more preferably from 5% to 25%, and most preferably from 10% to 20%, by total weight of such non-fibrous laundry detergent sheet, wherein said one or more nonionic surfactants is preferably selected from the group consisting of alkyl alkoxylated alcohols and combinations thereof.

13. The non-fibrous laundry detergent sheet according to claim 1, wherein said at least one film former is present in an amount ranging from 1% to 70%, preferably from 2% to 60%, more preferably from 5% to 50%, and most preferably from 10% to 40%, by total weight of such non-fibrous laundry detergent sheet; wherein said at least one film former comprises one or more water-soluble polymers; wherein preferably said one or more water-soluble polymers are selected from the group consisting of polyalkylene glycols, polyvinyl alcohols, starch or modified starch, cellulose or modified cellulose, polyacrylates, polymethacrylates, polyacrylamides, polyvinylpyrrolidones, and combinations thereof; wherein more preferably said one or more water-soluble polymers are selected from the group consisting of polyethylene glycols, polyvinyl alcohols, starch or modified starch, cellulose or modified cellulose, and combinations thereof.

14. Use of the non-fibrous laundry detergent sheet according to claim 1, for cleaning fabrics, preferably for removing stains and/or odors from fabrics.

15. Use of the non-fibrous laundry detergent sheet according to claim 1, for pre-treating fabrics before cleaning, by first wetting a section of the fabrics in need of pre-treating, and then directly contacting said unitary non-fibrous laundry detergent structure, or a piece thereof, with said wetted section of the fabrics.
